(19) United States
(12) Patent Application Publication
(10) Pub. No.: US 2015/0154693 A1
(43) Pub. Date: Jun. 4, 2015

(54) COMMUNITY TRADING PLATFORM

(71) Applicant: Xcite Deal, Inc., Atlanta, GA (US)

(72) Inventors: Baruh Hayut, Atlanta, GA (US); Paul Harrison, Atlanta, GA (US)

(21) Appl. No.: 14/559,438

(22) Filed: Dec. 3, 2014

Related U.S. Application Data
(60) Provisional application No. 61/911,790, filed on Dec. 4, 2013.

(51) Int. Cl. G06Q 30/08

(52) U.S. Cl. CPC G06Q 30/08

(57) ABSTRACT

A community trading platform may be provided. The platform may be, for example, an internet-based trading system for non-securitized goods and services. More particularly, the platform may be comprised of methods and systems that are community based, creating virtual communities, collecting their data, displaying the community data, and presenting communication channels and market commands. In this way, the platform of the present disclosure may create a network of cross-matched and complementary communities, interconnecting markets for consummating transactions.

### RELATED APPLICATION

Under provisions of 35 U.S.C. §119(e), the Applicant claims the benefit of U.S. provisional application No. 61/911,790, filed Dec. 4, 2013, which is incorporated herein by reference.

### FIELD OF DISCLOSURE

The present disclosure generally relates to electronic commerce (“eCommerce”).

### BACKGROUND

Conventional eCommerce Systems usually involve a seller-centric model where individual buyers “shop” in isolation for deals from sellers at static prices. Even in applications touted as “buyer-centric,” where buyers are allowed to bid for the deals they want, these systems force buyers to operate in an isolated and uncoordinated fashion, thereby resulting in a virtual information vacuum. Sellers, even in the most seller-centric models, have no community where they can compete with other sellers in real time generating up-to-the minute data about the market.

The current models fall short of a true market where there is a dynamic and transparent placement and acceptance of bids and offers yielding best prices. Furthermore, the current models have also failed to realize the benefits of community, especially among buyers.

It is apparent that a need exists for a platform in which buyers and sellers can leverage the power of community, producing the buyer-community dynamics and the data that will drive live bilateral exchanges.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

It is an object of the present disclosure to provide a platform, comprised of methods and systems, that enable users to overcome the limitations of the conventional models by joining communities and using the community structure to 1) generate and share data within and between communities, 2) create coordinated bids within communities, 3) create community market networks, and 4) produce a real-time community data-driven exchange.

The platform may be configured to provide, for example, an internet-based, community trading system for non-securitized goods and services wherein users are divided into buyer and seller communities within markets and use the structures of community and data generated by the communities to place bids and offers and execute consummated transactions within a bilaterally-transparent live market exchange between said buyer and seller communities.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A is a block diagram of an operating environment for providing a community trading platform;

FIG. 1B is a block schematic showing a general overview of the platform components and the order in which they may be executed in some embodiments of the present disclosure;

FIG. 1C is an illustration of an embodiment of a community trading platform user interface;

FIG. 2 is a block schematic showing the constituent elements of Markets and Communities;

FIG. 3 is a flow chart illustrating a method for specifying filtration parameters;

FIG. 4 is a flow chart illustrating a method for creating a bid or offer;

FIG. 5 is a flow chart illustrating a method for populating the Community Market Form;

FIG. 6 is a flow chart illustrating a method for creating Block Bids;

FIG. 7 is a flow chart illustrating a method for creating Composite Communities;

FIG. 8 is a flow chart illustrating a method for linking Complementary Communities;

FIG. 9 is a flow chart illustrating a method for creating a Community context for intra- and extra-Community Communication Channels; and

FIG. 10 is a block diagram of a computing device enabled to perform the methods of the present disclosure.

### DETAILED DESCRIPTION

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

Embodiments of the present disclosure may provide a platform for forming matched and linked Communities that generate and share data to create exchanges and produce markets for standardized goods and services. The platform may be comprised of hardware and/or software components configured as, for example, a system capable of performing various methods. The platform of the present disclosure may allow users to select a Market by designating Industry Type, Category, and Criteria. These input variables, when combined with the user's Class (e.g., his role as a Buyer or Seller), may permit an assignment of the user to a Primary Community within the Market.

The platform may then match the user's Primary Community to a Primary Cross-Community (i.e., its primary trading partner within the Market). Once a Primary Community and Primary Cross-Community are formed and cross-matched, a market exchange may be established. The market exchange may be presented to users via a user interface (UI) associated with the platform.

Market exchange users may be enabled, via the UI, to input variables known as Conditions and Measures and input Price. If desired, Buyers may coordinate their input of Conditions, Measures, and Price in block bids.

Accumulating the bids and offers of two cross-matched Communities, embodiments of the platform may filter market items based on Conditions and Measures. Once result sets are obtained, the platform may stack and sort the result sets. The result sets may then be presented as UI “Tiles” in a bilaterally transparent manner to the cross-matched Communities.

Still consistent with embodiments of the present disclosure, the bilateral, Community-based live, real-time market may comprise Market Commands and Communication Channels. The Market Commands and Communication Channels may be presented to the platform user as UI elements. In this way, the platform may permit users to place and accept bids and offers by clicking on the Commands. For example, in some embodiments, Commands may be placed on or in proximity to the Tiles.

The Community and its relationship to other cross-matched Communities establishes the context for providing intra-Community and inter-Community Communication Channels. The Communication Channels may comprise, but not be limited to, for example, a Twitter hashtag feed, social media, group instant messaging, and Community chat rooms. In some embodiments, these Communication Channels may be displayed, for example, in the margins or other fields of the platform UI.

The Community data (e.g., the aggregated data of Primary Community and Primary Cross-Community members which it derives from bids, block bids, and offers), together with the Market Commands, Communication Channels, may constitute the Community Market Form. The Community Market Form may be used by the platform user to analyze Community data, communicate with other Community members, and to manually place or accept bids and offers. In turn, the platform may automatically match bids and offers, on a first-in-first-out basis where the users' input variables on Industry Type, Category, Criteria, Conditions, Measures, and Price precisely match.

The above has described some sample embodiments for linking a Primary Community to a Primary Cross-Community to form an exchange. Communities may be interconnected to other Communities in accordance to yet further embodiments of the present disclosure.

For example, in some embodiments, a market may be established for trading bundled goods and/or services. Such markets may be Composite Markets. The Primary Buyer Community and the Primary Seller Community within a Composite Market may each be linked to one or more Markets in which a component of the bundled goods and/or services is sold. Each of these linked Markets is a Component Market.

In other embodiments, Primary Buyer and Seller Communities may be cross-matched to Complementary Seller and Buyer Communities in Complementary Markets. Such cross-matches may be desirable where goods or services being traded in the primary Market complement those being traded in the complementary Market. For example, when a Buyer user selects a Complementary Seller Community, the platform may consider the Buyer as a member of the Primary Buying Community within the Complementary Market.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

Embodiments of the present disclosure may provide a virtual Community-based marketplace where users of like Classes (roles) are enabled to select a Market by Industry Type, Category, and Criteria and be assigned to a Primary Community and a Primary-Cross-Community (i.e., primary trading partner community). The platform of the present disclosure may be configured to aggregate the data of Primary Community and Primary Cross-Community members which it derives from bids, block bids, and offers to form Community data. The platform may then filter Community data by Conditions and Measures, stacked and sorted by Condition and Price, and present a platform user with a UI embodied as a Community Market Form. The UI may include active Commands (including, for example, but not limited to, a Command for Buyer-coordinated Block Bidding) and Communication Channels. In this way, the Community Market Form may produce live Community data and bilateral transparency to a Primary Community within a Market and to its Primary Cross-Community. Still consistent with embodiments of the present disclosure, the Community Market Form may be enhanced by links to Component Communities and Complementary Communities.

The principles and operations associated with providing a live Community-based marketplace to a platform user in accordance to the various embodiments disclosure herein may be better understood with reference to the drawings and the accompanying description, it being understood that these drawings are given for illustrative purposes only and are not meant to be limiting.

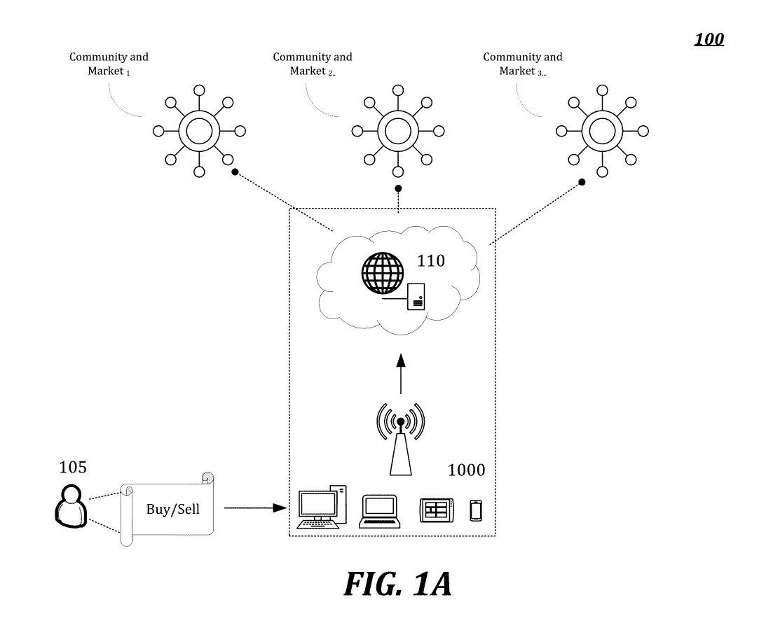

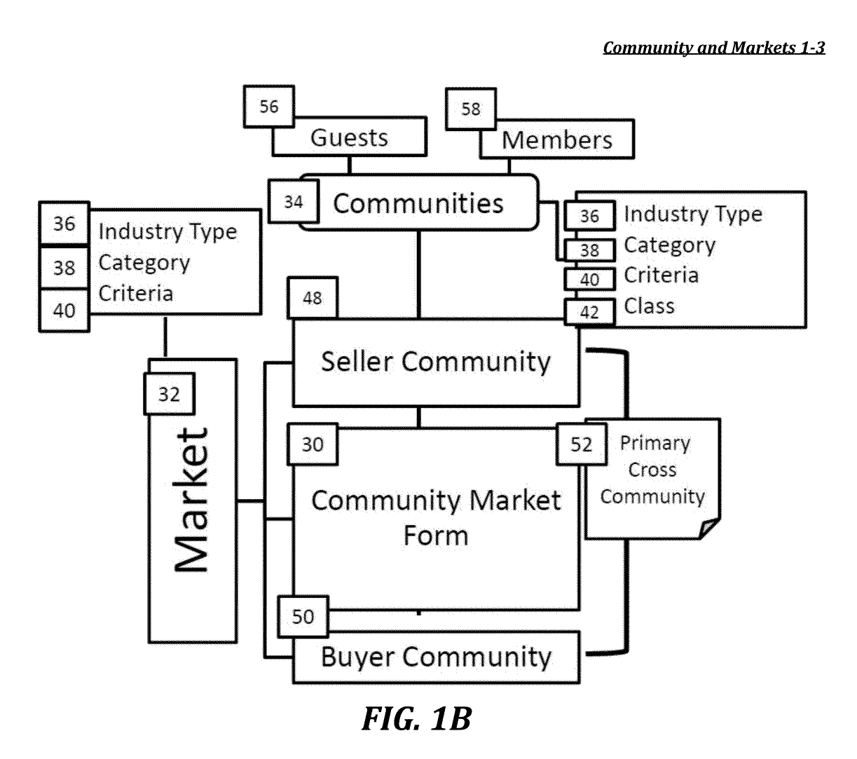

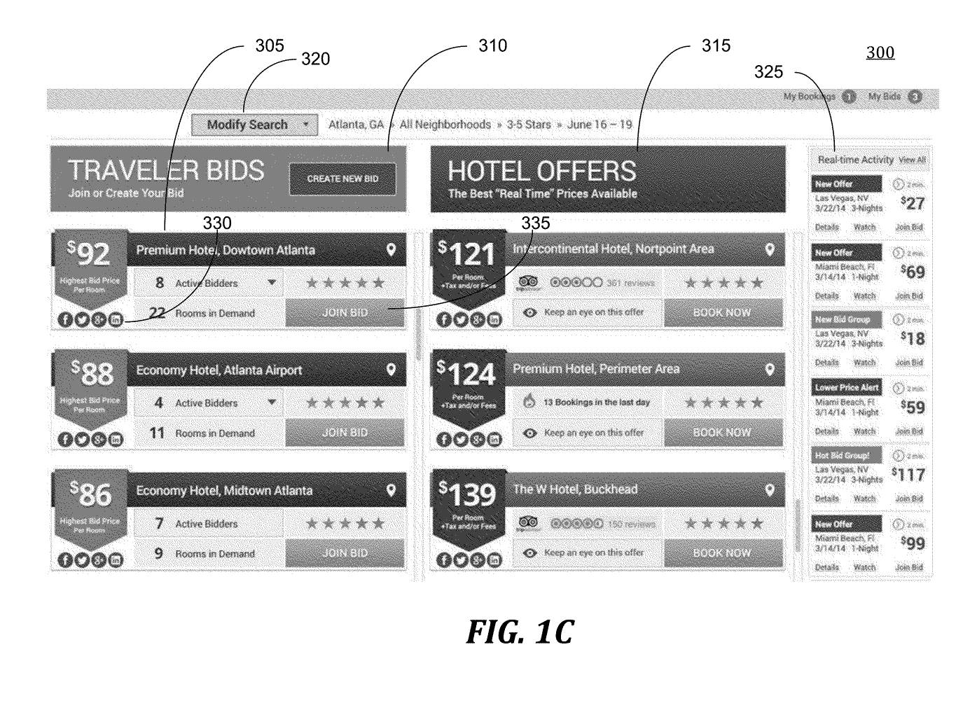

FIG. 1A illustrates one possible operating environment through which a platform consistent with embodiments of the present disclosure may be provided. By way of non-limiting example, a platform 100 may be hosted on a centralized server 110, such as, for example, a cloud computing service. A user 105 (e.g., a buyer/or seller) may access platform 100 through a software application. Buyers and sellers may be provided with a different portal to platform 100. The software application may be embodied as, for example, but not be limited to, a website, a web application, a desktop application, and a mobile application compatible with a computing device 1000.

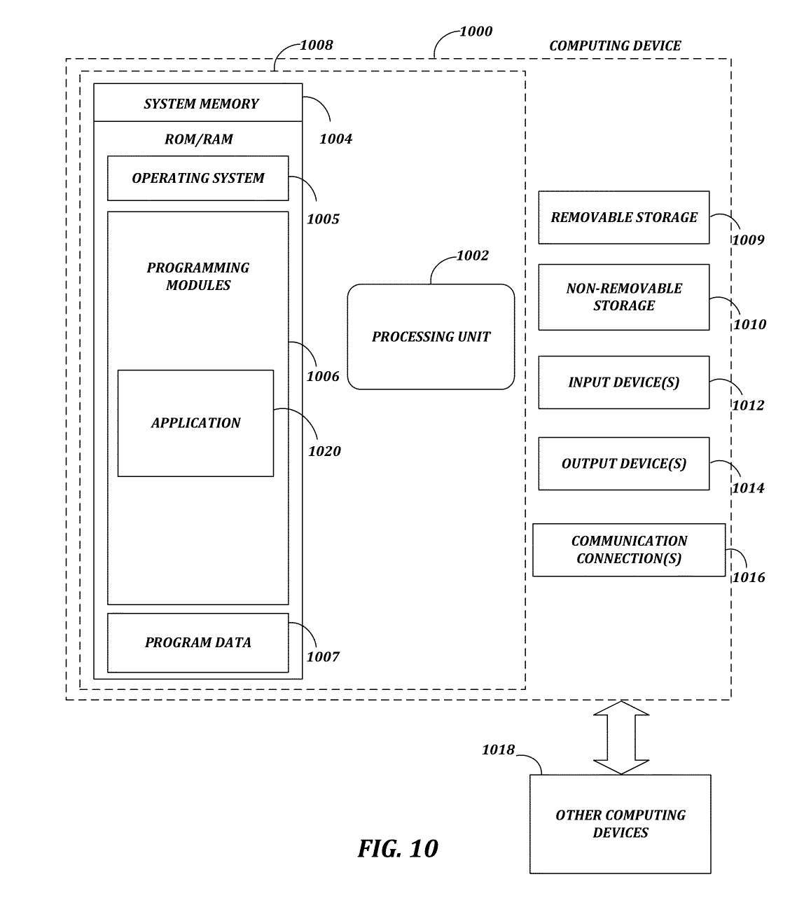

As will be detailed with reference to FIG. 10 below, the computing device through which the platform may be accessed may comprise, but not be limited to, for example, a desktop computer, laptop, a tablet, or mobile telecommunications device. As will be detailed with reference to FIG. 10 below, the computing device through which the platform may be accessed may comprise, but not be limited to, for example, a desktop computer, laptop, a tablet, or mobile telecommunications device. Though the present disclosure may be written with reference to a mobile telecommunications device, it should be understood that any computing device may be employed to provide the various embodiments disclosed herein.

Referring now to FIG. 1B, the following explains the method by which Markets and Communities 1-3 (as illustrated in FIG. 1A) are formed. The immediate goal of a platform user 105 may be to get to the Community Market Form (Block 30). In order to get to this Form, a Market (Block 32) may be identified and user 105 must be affiliated with a Primary Community (Block 48 or 50) within the Market.

In order to identify a Market (Block 32), three parameters may be specified: Industry Type (Block 36), Category (Block 38), and Criteria (Block 40). These parameters may be specified by user 105 manually in a search field or they may be determined automatically when the user enters a specific portal. In various embodiments, the parameters associated with the user and/or the products/services that the user is promoting through platform 100.

Industry Type (Block 36) may be a broad industry classification which may be configurable by a platform operator. As an example, in some embodiments of the present disclosure, Industry Type may be configured to include Travel Industry. Accordingly, platform 100 may allow for multiple Industry Types and for alternate configurations.

Category (Block 38) may be configured on a many-to-one basis in relation to Industry Type. It may be a more specific classification than Industry Type identifying a type of product or service with sufficient granularity to permit the selection of Criteria (Block 40) which, in turn, may identify a Market for the product or service. As an example, in some embodiments of the present disclosure, if the Industry Type is Travel Industry, a Category of Hotel Rooms may be added. A Category may include Sub-Categories to allow both drilling down and bundling of goods and/or services within a Composite Market. As example, in the Industry Type Travel Industry, a Category for Packaged Travel might be created and Sub-Categories of Hotel Rooms, Commercial Air Travel, Rental Cars and Activities might be added. Thus, a Category for a product or service could itself be a bundling of other products and services.

Criteria (Block 40) may be configured on a many-to-one basis in relation to Category. Criteria may constitute a further sub-classification of Industry Type and Category which ultimately identifies a Market (Block 32). As an example, in some embodiments of the present disclosure, a Criteria of Location might be added to the Industry Type Travel Industry where the Category is Hotel Rooms. In said embodiments, once the Location is specified (say, the City of Atlanta), platform 100 may have the information necessary to open a virtual Market (Block 32) in which the item (Hotel Rooms in the Location of Atlanta) may be traded. As another example, a Criteria of Route may be added to the Industry Type Travel Industry where the Category is Commercial Air Travel. In this instance, the Criteria might have two result fields, one result for Origin and one for Destination.

In order to proceed to the Community Market Form (Block 30) the user must first be affiliated (either as a guest user, an established user with a user ID, or as a Community member) with a Primary Community (Block 48 or Block 50). Affiliation of user 105 with a Primary Community may require identification of the relevant Market (Block 32) plus identification of user's Class (Block 42). In the illustrated embodiment of FIG. 1B, the relevant Classes may be “Buyer” and “Seller”.

The Community Market Form (Block 30) may display the bids and offers of the user's affiliated Primary Community as well as those of said Community's Primary Cross-Community (Block 52). In the illustrated embodiment of FIG. 1B, if the user's Primary Community is a Buyer Community (Block 48), the Primary Cross-Community may be the Seller Community within his Market (Block 50). If the user's Primary Community is a Seller Community (Block 50), the Primary Cross-Community may be the Buyer Community within his Market (Block 48).

Once the user's affiliation with both a Primary Community and Primary Cross-Community is determined, the Community Market Form (Block 30) may be displayed. Accordingly, user 105 may be provided with the Community Market Form UI either as a guest (Block 56) with a guest id or other session identifier that is linked to the Community's Community ID, or as a Community member (Block 58) with a User ID that is linked to the Community's Community ID.

FIG. 1C illustrates one embodiment of a UI 300 associated with platform 100. UI 300 may include tiles 305. Tiles 305 may include communication channels 330 and market commands 335. They may also display additional information associated with the item/product/service being offered (e.g., bidders, ratings, and the like). Tiles 305 may be organized based on buyers 310 and sellers 315. Furthermore, tiles may be filtered and sorted based on parameter and condition inputs 320. A live feed may be presented in a UI portion 325. It should be understood that, although the illustrated embodiment shows traveling and hotel offers, platform 100 may be adapted to any type of product and/or service.

### III. Platform Operation

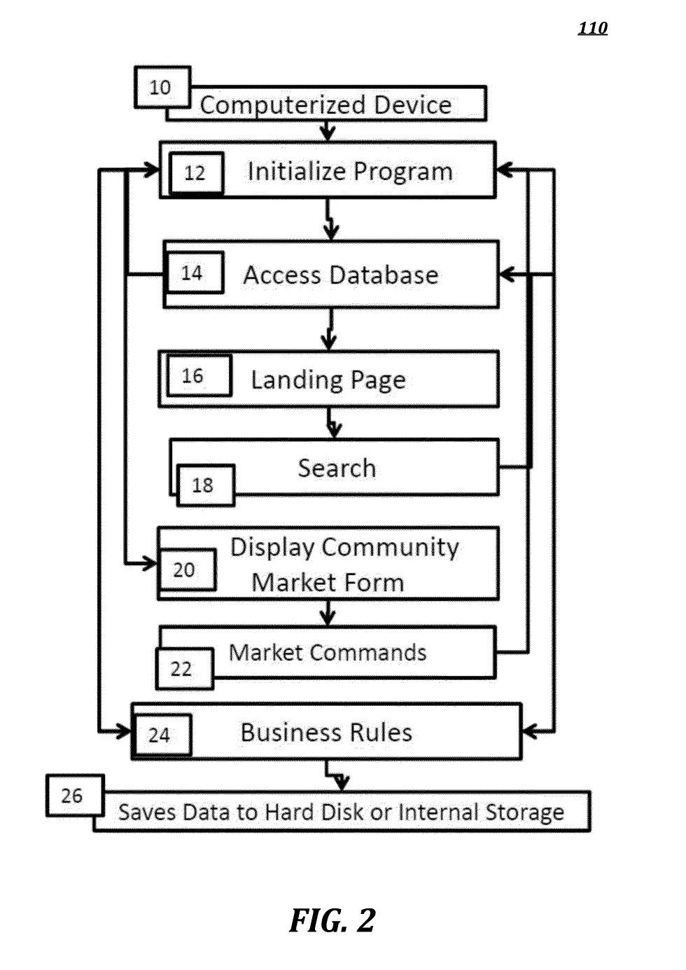

FIGS. 2-10 are flow charts setting forth the general methods and stages involved in providing platform 100. The methods may be implemented using a computing device 1000 as described in more detail below with respect to FIG. 10.

Although methods have been described to be performed from the perspective of user 105 via platform 100, it should be understood that, in some embodiments, different operations may be performed by different networked elements in operative communication with computing device 1000 in order to provide user 105 with the described features and functionality. For example, server 110 and/or computing device 1000 may be employed in the performance of some or all of the stages in the methods. Moreover, server 110 may be configured much like computing device 1000 and, in some instances, be one in the same embodiment.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method @00 will be described in greater detail below.

Referring now to the drawings, FIG. 2 is a flow chart showing a broad, general overview of a method that may be performed by platform 100 (e.g., server 110). Block 10 specifies that a computerized device must be used such as, for example, computing device 1000 As will be detailed below with reference to FIG. 10, in some embodiments the computing device 1000 may have a minimum of 512 RAM and an 8 GB disk or 8 GB of internal storage. The type of operating system (OS) is not critical to the operation of the technology and might be, e.g., a Windows, Droid or Apple (Mac) OS. Use any standard Browser, e.g., Internet Explorer, Firefox, or Safari, where network access is available to the internet and public websites.

A user 105 may access server 110 via a web-address and be presented with, for example, a landing page. In response, platform 100 may initialize a web application program (Block 12). Platform 100 may access the database (Block 14) to display the Landing Page (Block 16), creating a connection. The Landing Page may contain a search feature (Block 18). Once user 105 has entered the minimal search parameters, the Community Market Form may be displayed (Block 20). It should be understood that, in some embodiments, user 105 may access platform 100 via an application installed on the user's computing device (e.g., computing device 1000).

Server 110 may receive Market Commands (Block 22) as actions taken by user 105 (e.g., by clicking on the Community Market Form. Market Commands provided to the Buyer via platform 100 may include, but are not limited to, for example: Buy Now (or Accept Offer), Create Bid, Create Block Bid, and Update/Cancel Bid. Market Commands provided to a seller via platform 100 may include, but are not limited to, for example: Create Offer, Update/Cancel Offer and Accept Bid. Each Market Command may cause platform 100 to initialize the program (Block 12), then repeats Block 14 and Block 20, then proceeds to Block 24.

Upon entering stage Execute Business Rules (Block 24), platform 100 may be configured to send a message to a service through a port containing data variables from the particular Market Command, locate a Business Rules process definition that matches the variables as indexed conditions, execute the logic, manipulate the data, and proceed to Block 26 where data is stored.

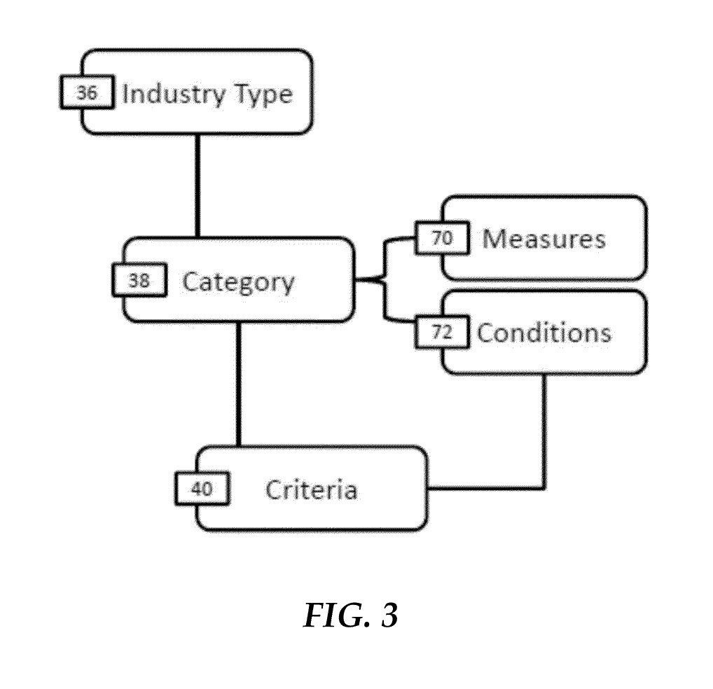

Turning now, to FIG. 3, the following is a description of the method by which platform 100 may generate a Community Market Form displaying bids and offers of the user's Community and the Primary Cross-Community.

Before accessing the Community Market Form, user 105 may have already designated the relevant Industry Type (Block 36) and Category (Block 38) and may have entered Criteria results (Block 40). The Community Market Form may permit the additional input of Measures (Block 70) and Conditions (Block 72).

Measures (Block 70) may be configured on a many-to-one basis in relation to Industry Type (Block 36) and Category (Block 38); Measures may help to quantify the item being traded. The types of Measures used may be determined by a platform operator and are intended to be tailored to the type of item being traded. As examples, Measures may include the number of items being traded; they may also include a start date and/or a time period, as would be the case in items that are rented or services that are rendered by the hour.

Measures may not affect the definition of Community. For example, where the user does not specify a Measure (Block 70), platform 100 may enable the platform operator to set default Measures for each Market or Community. Consistent with embodiments of the present disclosure, this would be desirable in a case where the absence of a Measure would result in a display of data on the Community Market Form that is too large for the typical user to readily understand.

Conditions (Block 72) may be configured on a many-to-one basis in relation to Industry Type (Block 36) and Category (Block 38) and may have a context that is related to Criteria (Block 40). Conditions may provide additional information to standardize a product or service so that it can be valued and traded.

The types of Conditions used would be determined the platform operator and are intended be tailored to the Market of the item being traded. As examples, Conditions may comprise, but not be limited to, a star rating, a name brand, or a sub-Location such as a Neighborhood or one or more airports (with a context related to Criteria of Location or Route). Conditions may be optional to Buyer users (who may care more about price than identifying a standardized product) and may not affect the definition of a Community. Buyer users may specify multiple, mutually-exclusive Conditions. For example, embodiments in which a five-star-rating is a type of Condition, user 105 may specify both a three- and a four-star rating.

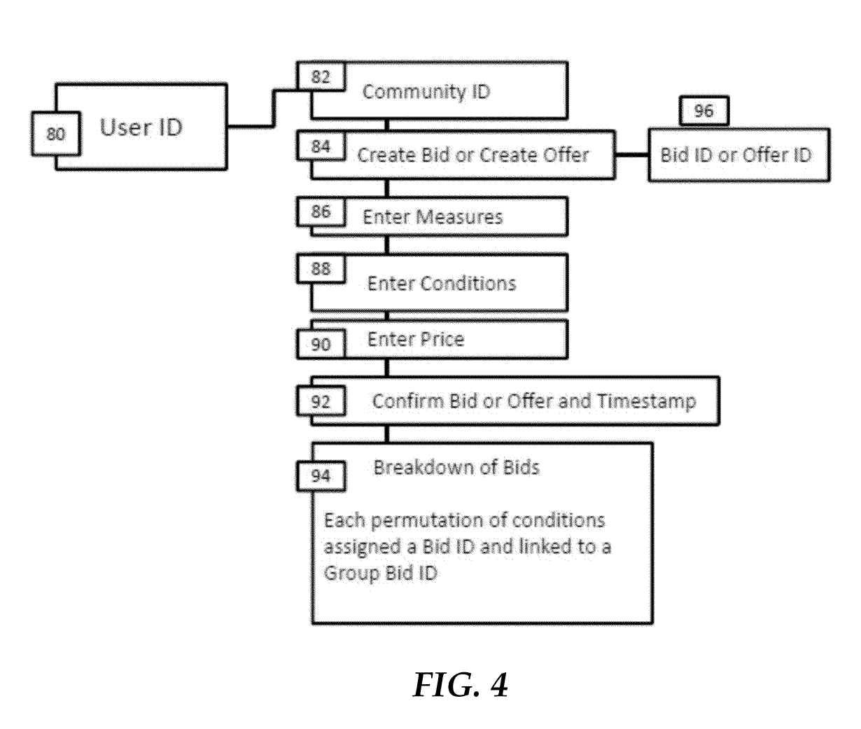

Platform 100 may provide a UI in which the Community Market Form displays bids and offers from a user's affiliated Primary Community and Primary Cross-Community. Turning now to FIG. 4, the following explains an embodiments of platform 100's design as it relates to a bid or an offer.

To recapitulate, embodiments of platform 100 may enable users in Buyer Communities to place bids and users in Seller Communities to place offers. To place a bid, a user joins or may be joined by platform 100 to a Community whose Class is Buyer. To place an offer, a user joins or may be joined by platform 100 to a Primary Community whose Class is Seller. When entering a Community, user 105 who has not already entered a profile may be prompted to do so. Upon entering a profile, platform 100 may assign a User ID (Block 80) to user 105. Joining a Community links a User ID (Block 80) to a Community ID (Block 82).

As previously stated, the Community ID may establish the Industry Type, Category, Criteria, and Class for a particular item/product/service or a transaction associated therewith. The Community member may enter a bid or offer, via platform 100, by selecting a Command Create Bid or Create Offer (Block 84). In turn, a Bid ID or an Offer ID is created (Block 96). Platform 100 may then prompt user 105 to enter Measures (Block 86) if the system default Measures are not acceptable. Similarly, platform 100 may prompt user 105 to enter Conditions, if any (Block 88). Furthermore, platform 100 may prompt user 105 to enter Price (Block 90). Finally, platform 100 may ask user 105 to confirm a bid or offer and then it may assign a date-time stamp (Block 92).

Consistent with various embodiments of the present disclosure, platform 100 may allow for multiple bids. Multiple bids may occur when user 105 selects one or more mutually exclusive Conditions. For example, embodiments in which a Condition of a five-star rating system is enabled, selecting a three-star and a four-star rating would present mutually exclusive Conditions if only one item is being sought for purchase. Moreover, in the event of a multiple bid, platform 100 may break down the multiple bid (Block 94). For example, platform 100 may generate a Bid ID for each permutation of mutually exclusive Conditions and links the Bid IDs to a Group Bid ID (Block 94).

Still consistent with various embodiments of the present disclosure, platform 100 may automatically match bids and offers, on a first-in-first-out basis where the users' input variables on Industry Type, Category, Criteria, Conditions, Measures, and Price precisely match. Platform 100 may aggregate Sellers' Offers to satisfy bids for Measures greater than single units, consistent with user and system preferences as to whether more than one vender may fill a bid. The system will not allow a multiple bid to result in multiple unintended purchases. When a match (or acceptance occurs with respect to a Bid ID that is linked to a Group Bid ID, all of the bids associated with the Group Bid ID are frozen; then upon consummation of a Purchase, all of the linked bids (except the one resulting in the Purchase) are cancelled.

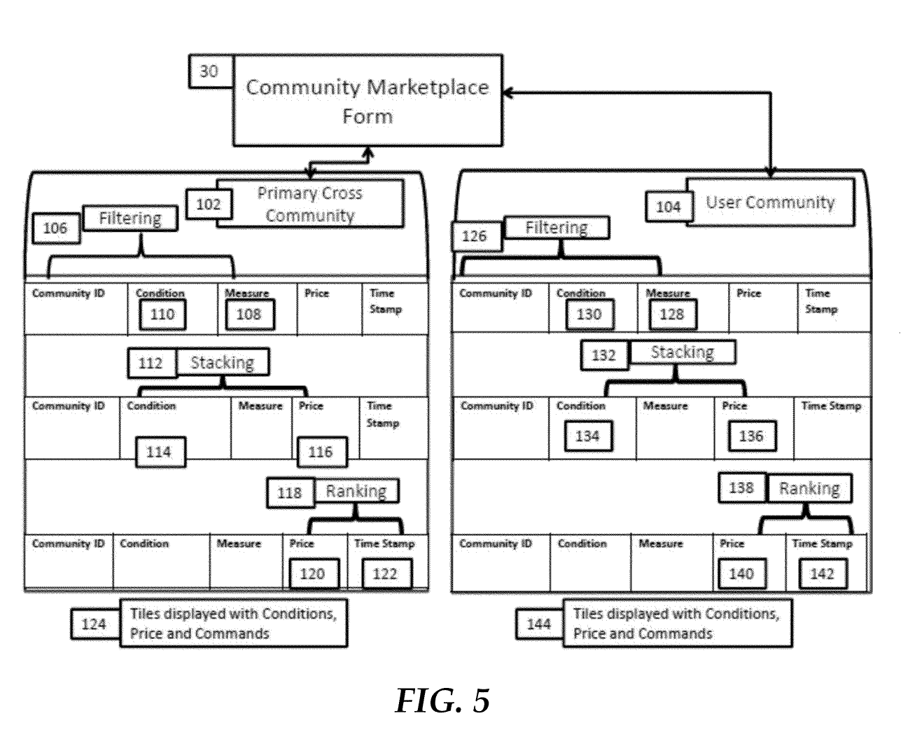

Turning now to FIG. 5, the following describes an algorithm that may be employed by platform 100 to display the Community Market Form. The Community Market Form (Block 30) may have multiple columns, tabs, or fields, including at least one for the bids/offers of the Primary Community of the user (Block 104) and one for the bids/offers of the Primary Cross-Community (Block 102). The bids/offers of the user's Primary Community and Primary Cross-Community may be filtered, stacked, and ranked according to a Display Algorithm, then are presented as command-activated Tiles.

One embodiments of a Display Algorithm for a two-column Community Market Form, involving either a Buyer or Seller Primary Community and a Seller or Buyer Primary Cross-Community, is as follows. The user's Primary Cross-Community (Block 102) may be displayed as follows.

A filter (Block 106) may be applied to the bids/offers of the Primary Cross-Community. Bids/offers of the Primary Cross Community may be filtered by user's Measures (Block 108) and Conditions (Block 110). If the user has not specified Measures, platform 100's default Measures may be used.

If the user is a Buyer, only those Sellers' offers that are sufficient in terms of Measures (either aggregated or non-aggregated) may be displayed. In said embodiment, if the user is a Seller, only those bids the user can satisfy with his own Measures (either aggregated or non-aggregated) may be displayed.

If the user is a Buyer, only Sellers' offers that meet the user's Conditions (or in the case of a multiple bid, a subset of the user's Conditions) may be displayed. If the user is a Seller, only Buyers' bids (or a subset thereof) that a Seller can satisfy may be displayed.

The filtered bids/offers of the Primary Cross-Community are stacked (Block 112). Bids/offers are stacked by Conditions (if any) (Block 114) and Price (Block 116). All Permutations of Condition and Price may be organized into separate stacks.

The filtered and stacked bids/offers (Tiles) of the user's Primary Cross-Community may be ranked (Block 118). If the user is a Buyer, Tiles representing Seller offers may be displayed. Sellers' offer Tiles may be ranked first by Price (lowest to highest) (Block 120) and second by the time stamp of the offer (earliest to latest) (Block 122). If the user is a Seller, Tiles representing Buyer bids may be displayed. Buyers' bid Tiles may be ranked first by Price (highest to lowest) (Block 120) and second by the time stamp of the bid (earliest to latest). In various embodiments, Price may be listed as the average price per single unit.

Tiles may displayed for the user's Primary Cross Community (Block 124). Each Tile may display its Conditions and its Price. Tiles with different Prices may be aggregated into a single Tile if the Conditions are identical. If aggregated, Tiles may be ranked first by Price and second by time stamp. If the user is a Buyer, the lowest-Price offer may be displayed on an aggregated Tile. If the user is a Seller, the highest-Price bid may be displayed on an aggregated Tile. Tiles may be populated with Commands allowing Seller users to sell (by accepting a high bid) and allowing Buyer users to buy (by accepting a low offer).

An embodiment of the Display Algorithm for the user's Primary Community (Block 104) is as follows. A filter (Block 126) may be applied to the bids/offers of the Primary Community. Bids/offers of the Primary Community may be filtered by user's Measures (Block 128) and Conditions (Block 130). If the user has not specified Measures, platform 100's default Measures may be used.

If user 105 is a Buyer and the Category of the Market is configured to include a Measure that is a range of times or dates, only those Buyer Community members' bids whose times/dates lie within the user's date/time range may be included. All bids from the Buyer's Community matching the user's Conditions (or, in the case of a multiple bid, a subset thereof) which any of the displayed Sellers' filtered offers could satisfy (except for Price) may be displayed.

If the user is a Seller and the Category of the Market is configured to include a Measure that is a range of times or dates, only those Seller Community members' offers whose times/dates lie within the user's date/time range may be included. All offers from the Seller Community matching the user's Conditions which could satisfy any of the displayed Buyers' filtered bids (except for Price) may be displayed. The filtered bids/offers of the user's Primary Community may be stacked (Block 132). Bids/offers may be stacked by Conditions (Block 134) and Price (Block 136). All permutations of Condition and Price may be organized into separate stacks.

The filtered and stacked offers/bids of the user's Primary Community may be ranked (Block 138). If the user is a Buyer, stacks may be ranked first by Price (highest to lowest) (Block 140) and second by the time stamp of the bid (earliest to latest) (Block 142). If the user is a Seller, stacks may be ranked first by Price (lowest to highest) and second by the time stamp of the offer (earliest to latest). In the typical case, Price may be the average price per single unit.

Tiles are displayed for the user's Primary Community (Block 144). Each Tile may display its Conditions and its Price. Tiles with different Prices may be aggregated into a single Tile if the Conditions are identical. If aggregated, Tiles may be ordered first by Price and second by time stamp. If the user is a Buyer, the highest-Price bid may be displayed on an aggregated Tile. If the user is a Seller, the lowest-Price offer may be displayed on an aggregated Tile. Tiles may be populated with Commands allowing Seller users to create or modify an offer and allowing Buyer users to create or modify a bid.

In various embodiments of platform 100, the user's own bid or offer may be given prominence on the Community Market Form so that it is readily identifiable to user 105. Market Tiles may refresh when bids and offers are placed and accepted so that a live, dynamic view of the Market is presented to users.

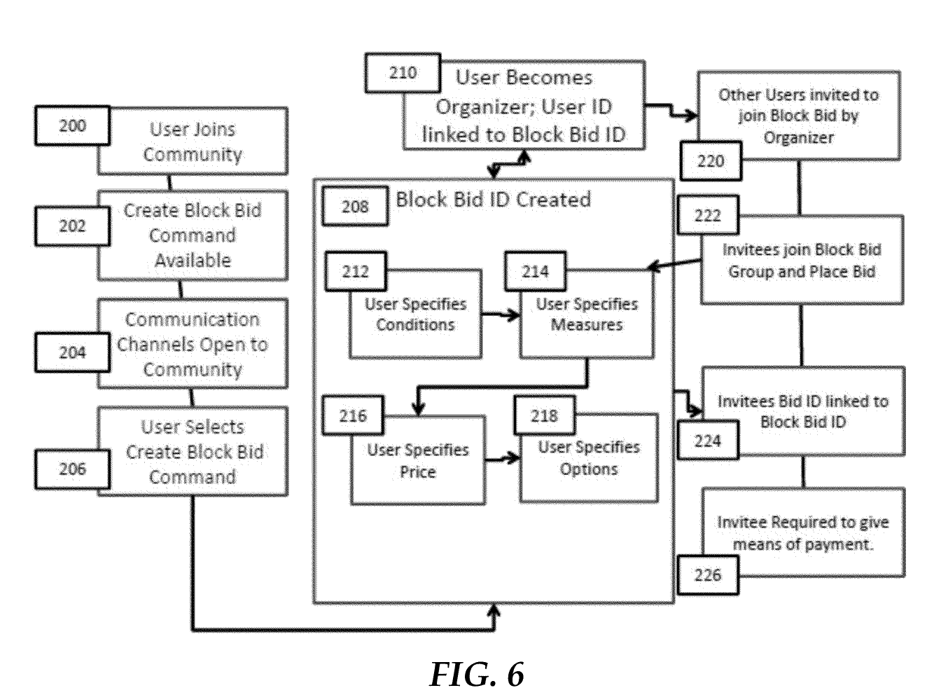

Turning now to FIG. 6, the following explains an embodiment for performing Block Bidding. For example, on every Community Market Form, an option to join the Community may be presented to user 105.

A Buyer user who wishes to place a Block Bid first may first join the Community if he has not already done so (Block 200). A Create Block Bid Command may then become available (Block 202). Subject to limitations that may be in place to protect users, whenever user 105 joins a Community, Communication Channels may open connecting user 105 to other members of the Community (Block 204). Communication Channels give user 105 an avenue for organizing a Block Bid.

Platform 100 may enable user 105 to select the Command to create a Block Bid (Block 206). A Block Bid ID may be created (Block 208). User 105 may become an Organizer for a Block Bid Group and his User ID may be linked to the Block Bid ID (Block 210) with a flag or other notation indicating that he is the Organizer. The Organizer may then be prompted to specify Conditions (Block 212). These Conditions may be applied to the entire Block Bid Group.

The Organizer may be prompted to specify maximum Measures (for each member of the Block Bid Group, not for the Group as a whole) (Block 214). These maximum Measures may apply to each participant in the Block Bid Group.

The Organizer may be further prompted to specify Price per unit (Block 216). This Price may bind each member of the Block Bid Group.

Block Bid Options may be presented to the Organizer (Block 218). In various embodiments of platform 100, such Options would include at minimum;
Block Bid Group Privacy Options (whether a Block Bid Group is open to all Community members or is private, e.g., by invitation, social network, or password entry only);
Communication Options (e.g., whether a separate Communication Channel (such as a private chat room) may be available to the members of the Block Bid Group); and
Block Bid Group Measure Options such as, but not limited to:
   the minimum and/or maximum number of persons who are allowed to participate as Block Bidders;
   the maximum number of Sellers who are allowed to accept the Block Bid Group members' bids;
   the minimum number of bids that each Seller must accept;
   whether consummation of a purchase with one Seller is conditional upon fulfillment of minimums by other Sellers; and
   if the item being sought by the Block Bid Group is partitionable whether it must be sold/rented in its entirety to the Block Bid Group members (for example if the item being sought is a charter flight—whether the entire plane must be dedicated to the Block Bid Group).

The Organizer may be enabled to invite other users 105 to join the Block Bid Group. Invitees of the Organizer may be invited to join the Organizer's Community (if they are not already members) and to join the Block Bid Group in accordance with the Block Bid Group Privacy Options specified by the Organizer (220). In various embodiment of platform 100, if an Organizer creates a Block Bid Group, a Tile for the Block Bid may appear on the Community Market Form of all invitees eligible to join the Block Bid Group. When an invitee selects a “Join Block Bid” Command on the Tile, he or she may be provided with a UI to participate in the Block Bid (Block 222).

Each Block Bid Group invitee may, consistent with the Organizer's maximum Measures, specify his or her own Measures (Block 214). Upon confirmation by the invitee, platform 100 may generate a bid for the invitee that is linked to the Block Bid Group ID (Block 224).

Invitees may leave the Block Bid Group (thereby cancelling their bids) up to the point where a purchase is finalized. The Organizer may cancel a Block Bid up to the point where a purchase is finalized.

Within a Block Bid Group, Buyer participants do not compete against one another; the Price may be determined solely by the Organizer. Each Block Bid Group participant must submit a means of payment (Block 226).

When a Block Bid is accepted by one or more Sellers, each individual participant's credit card is charged for his or her own share. To comply with legal requirements, certain users may be barred from organizing or joining a Block Bid Group.

Consistent with embodiments of platform 100, Block Bids are filtered, stacked, and ranked in the same manner as other Bids. The user's own Block Bid may, however, be prominently visible to the user on the Community Market Form.

Still consistent with embodiments of platform 100, when a Seller accepts a Block Bid in part, his acceptance may be made conditional upon acceptance by other Sellers. Sellers may set an expiration time for a conditional acceptance.

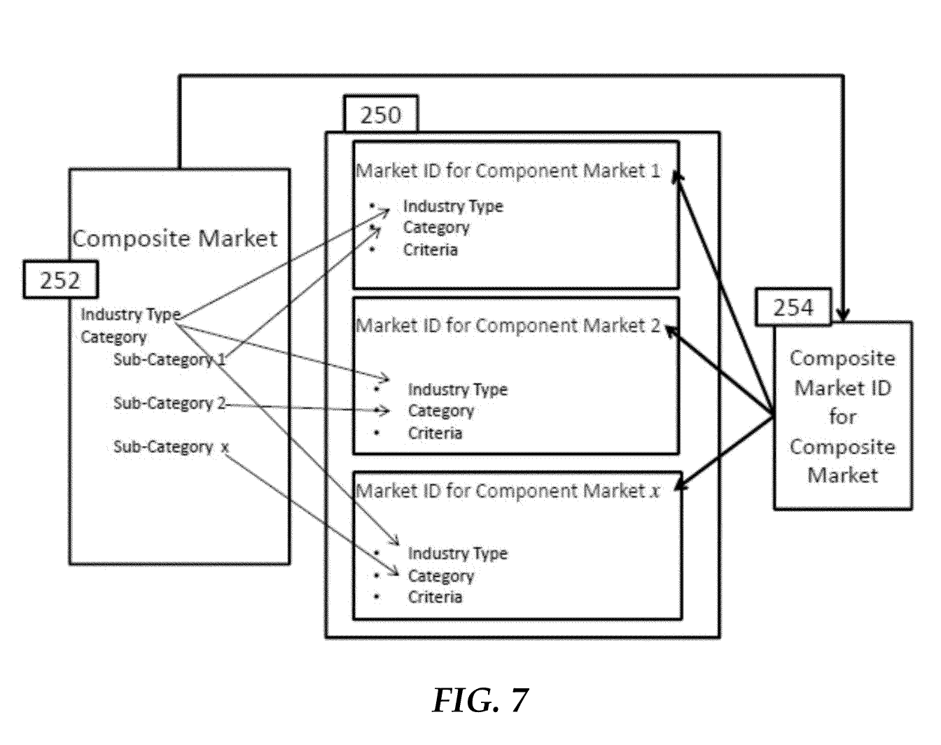

Turning to FIG. 7, the following demonstrates an embodiment for handling Composite Markets involving a bundling of goods and/or services (each good and/or service being an item traded in a Component Market). As stated above, a Market may be defined by Industry Type, Category, and Criteria. Each Market may be assigned a Market ID (Block 250).

A Composite Market may be defined by Industry Type and Category (which may include Sub-Categories) (Block 252). Each Composite Market may be assigned a Composite Market ID (Block 254). Component Communities may be defined by linking a Composite Market ID to the Market IDs of all of the Component Communities it encompasses. (Blocks 254 and 250).

The Industry Type of the Composite Market may be the same as the Industry Type of each of the Component Markets. If the Component Markets all have the same Category, the Composite Market may be configured with that Category as well. If the Component Markets of a given Composite Market have multiple Categories that differ from one another, said Categories may be configured as Sub-Categories of the Composite Market (Block 252). Each Sub-Category of the Composite Market corresponds to a Category of one or more of the Component Markets (Blocks 252 and 250). All Criteria, Conditions, and Measures may be the same for each of the linked Sub-Categories and Categories.

A Buyer may operate in a Composite Community when he or she enters a Component Community (which is his or her Primary Community) and indicates (via search or placing a bid) that he or she wishes to purchase items from at least two different Component Seller Communities with which his Primary Community is cross-matched.

In various embodiments, the Community Market Form for a Composite Market is generated according to the same general rules as described above in FIG. 5, except that the following special rules may be applied:

1) When user 105 enters Conditions and Measures, he does so in multiple sets so that Conditions and Measures are entered separately for every item that is from a different Component Market;

2) When user 105 places a bid or offer in or is affiliated through a search with multiple Component Communities (hereinafter, by way of illustration, Community A and Community B), he is deemed to be a member of a new Composite Community with other users who have also placed a bid or an offer in all the same Communities (i.e., in both Communities A and B);

3) If a Buyer indicates that he will only buy from a single vendor, his view of the Community Market Form may include only Sellers who have placed an offer in both Communities A and B. Otherwise, his view of the Community Market Form may include Sellers who have placed an offer in either Community A or Community B;

4) The Display Algorithm may filter by every set of Conditions and Measures user 105 has entered (i.e. the system filters for bids and offers among users who have specified identical Conditions and Measures for each of Items A and B); and

5) Price may be the total Price of Items A and B.

To illustrate the above, if a Buyer enters a Component Community A seeking Item A and also seeks an Item B from another Component Community B, his view of the Community Market Form may include only Buyers who 1) are seeking both Items A and B and whose Conditions and Measures are identical to his for each of Items A and B. Assuming a Buyer has not specified that he will only buy from a single vendor, Buyer's view of the Community Market Form may include only Sellers who 1) are able to sell either Item A or Item B and 2) whose Conditions and Measures match the Buyer's for the relevant Item(s) A and/or B.

A Seller may operate in a Composite Community when Seller sets up a profile specifying that he or she wishes to be active in a more than one Component Market linked to a Composite Market ID. Because Sellers sometimes operate in large geographic areas covering many Markets, Sellers' Composite Communities may be much more complex than those of Buyers. For this reason, the Sellers' Community Market Form may include the option to view (in multiple Forms or fields) different layouts and combinations of Component Market data in which there is bidder activity or in which the Seller user has placed an offer.

Platform 100 may perform automated matching of bids and offers in Composite Markets only when all components items of a Buyer's bid can be simultaneously satisfied by a Seller's or by multiple Sellers' aggregated offers.

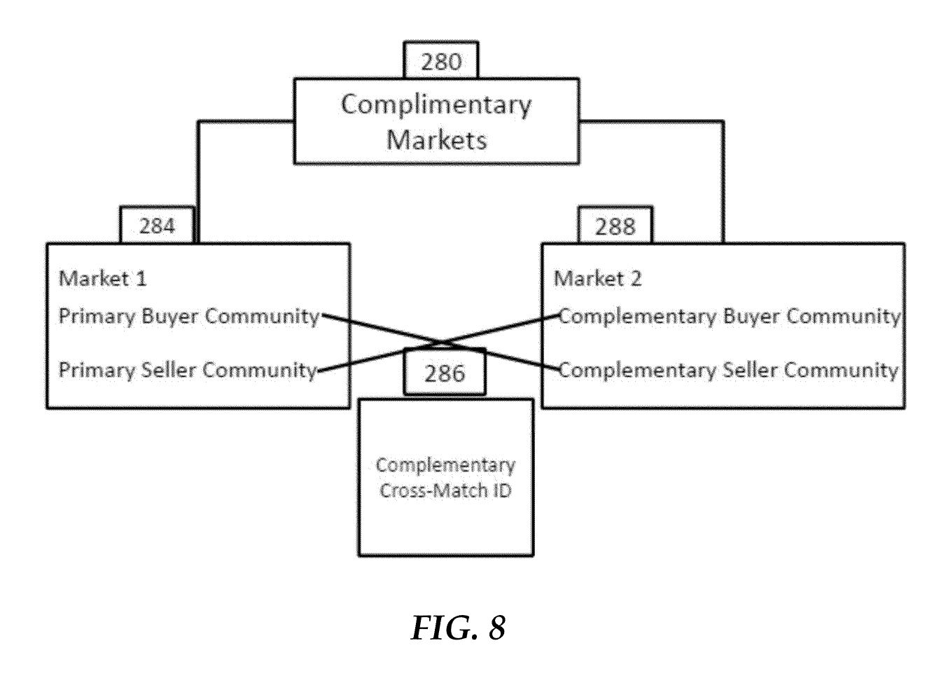

Turning now to FIG. 8, the following describes an embodiments for matching Primary Communities with Complementary Cross-Communities for the user's ease of navigation.

Complementary Communities may be communities that trade services and/or products that complement the products or services being traded by the user's Primary Community. In the embodiment illustrated in FIG. 8, multiple Markets (Blocks 284 and Block 288) may be linked together in a Complementary Market (Block 280) if the goods or services traded in the Markets are complementary.

Primary Communities within a Market (Block 284) may be cross-matched (Block 286) with Complementary Cross-Communities (Block 288). Complementary Cross-Matches may be linked to a Complementary Cross Match ID (Block 286) and may be given a priority ranking within the Market of the Primary Community being Cross-Matched. This may allow for prioritization of options when a navigation tool is used to navigate from a Primary Community to one or more Complementary Cross-Communities.

The following describes the method by which a Community Market Form may be created and presented when user 105 navigates from his Primary Community to a Complementary Cross-Community.

On each Community Market Form, there may be a navigation tool for user 105 who is a member of a Community to select a Complementary Cross-Community (if one exists). This can be accomplished with, for example, selectable menu options, tabs, or URLs within the UI.

When the Buyer-user selects a Complementary Cross-Community from his Community Market Form and navigates to it, said Community may be deemed to be the Buyer's new Primary Community for purposes of generating a new Community Market Form. The new Community Market Form may then generated according to the Standard Display Algorithm described with reference to FIG. 5 above.

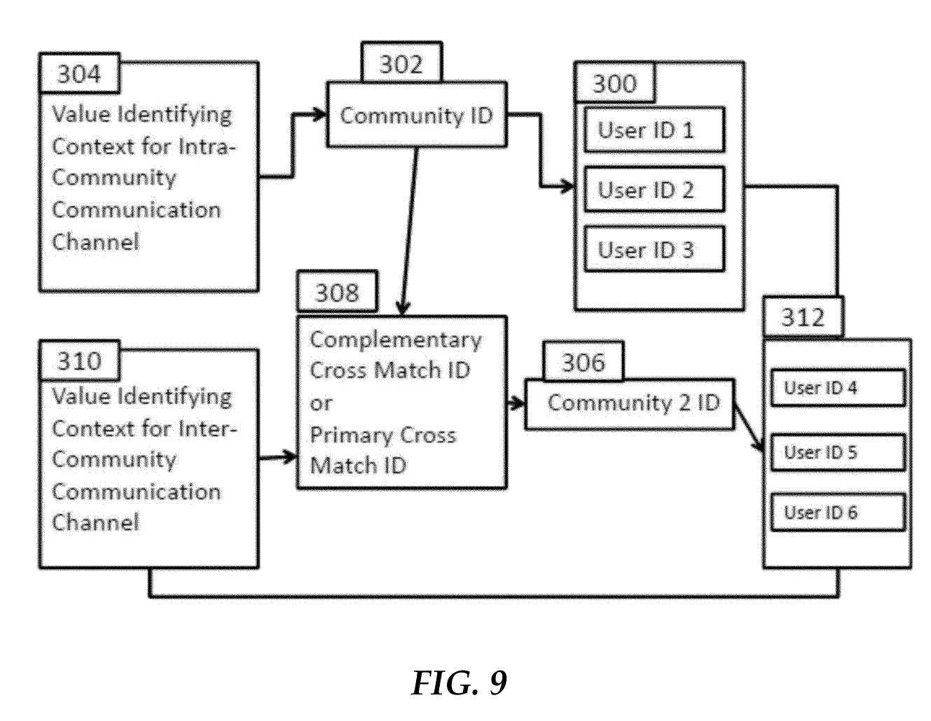

Turning to FIG. 9, the following demonstrates an embodiment for establishing the context for intra- and inter-Community Communication Channels. For example, every user who is a member of a Community may be linked by his or her User ID (Block 300) to the Community's Community ID (Block 302). The Community ID, which itself may be linked to a value such as a hashtag, a chat room name, or other identifier, creates the context (Block 304) for setting up a Channel such as a chat room, group instant messaging, or a hashtag twitter feed. The User IDs associated with the Community ID (Block 300) may establish the identities of those persons who are eligible to participate in the intra-Community Communication Channel.

When at least two Communities (Blocks 302 and 306) are linked together (e.g., by Primary Cross Match ID in a Primary Community to Primary Cross-Community match or by Complementary Cross Match ID in a Primary Community to Complementary Community match) (Block 308)), that link may provide the context for inter-Community Community Channels (Block 310).

The User IDs of the persons in each of the linked Communities (Block 300 and Block 312) may establish the identities of those persons who are allowed to create, send, or view Communications within an inter-Community Communication Channel.

### IV. Platform Architecture

Platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, platform 100 may be hosted on a centralized server, such as, for example, a cloud computing service. Although the aforementioned methods have been described to be performed by a computing device 1000, it should be understood that, in some embodiments, different operations may be performed by different networked elements in operative communication with computing device 1000.

Embodiments of the present disclosure may comprise a system having a memory storage and a processing unit. The processing unit coupled to the memory storage, wherein the processing unit is configured to perform the stages of the aforementioned.

FIG. 10 is a block diagram of a system including computing device 1000. Consistent with an embodiment of the disclosure, the aforementioned memory storage and processing unit may be implemented in a computing device, such as computing device 1000 of FIG. 10. Any suitable combination of hardware, software, or firmware may be used to implement the memory storage and processing unit. For example, the memory storage and processing unit may be implemented with computing device 1000 or any of other computing devices 1018, in combination with computing device 1000. The aforementioned system, device, and processors are examples and other systems, devices, and processors may comprise the aforementioned memory storage and processing unit, consistent with embodiments of the disclosure.

With reference to FIG. 10, a system consistent with an embodiment of the disclosure may include a computing device, such as computing device 1000. In a basic configuration, computing device 1000 may include at least one processing unit 1002 and a system memory 1004. Depending on the configuration and type of computing device, system memory 1004 may comprise, but is not limited to, volatile (e.g. random access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling computing device 1000's operation. In one embodiment, programming modules 1006 may include community forum application 1020. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and nonvolatile, removable and non-removable media implemented in any method or technology for storage of information, such as computer readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1004, including operating system 1005. While executing on processing unit 1002, programming modules 1006 (e.g., community forum application 1020) may perform processes including, for example, one or more of the methods as described above. The aforementioned process is an example, and processing unit 1002 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A method comprising:
establishing a primary community based on input variables;
matching the primary community with a primary cross-community;
establishing a market based on the primary community and the primary cross-community;
providing a list of bids and offers associated with the market established based on the primary community and the primary cross-community;
enabling a user to apply at least one of: a bid or an offer within the market, wherein the bid or the offer is configured to be associated with data aggregated from a plurality of users in at least one of the following: within the market and within other markets; and
enabling channels of communication for interacting with the listed bids and offers associated with the market.

2. The method of claim 1, wherein enabling the user to apply the bid comprises enabling the user to form a user group for aggregating a plurality of bids from the plurality of users.

3. A computer-readable medium having a set of instructions which when executed performed a method, the method executed by the set of instructions comprising:
establishing a primary community based on input variables;
matching the primary community with a primary cross-community;
establishing a market based on the primary community and the primary cross-community;
providing a list of bids and offers associated with the market established based on the primary community and the primary cross-community;
enabling a user to apply at least one of: a bid or an offer within the market, wherein the bid or the offer is configured to be associated with data aggregated from a plurality of users in at least one of the following: within the market and within other markets; and
enabling channels of communication for interacting with the listed bids and offers associated with the market.

4. The computer-readable medium of claim 3, wherein enabling the user to apply the bid comprises enabling the user to form a user group for aggregating a plurality of bids from the plurality of users.

5. A community trading system comprising:
a memory storage; and
a processing unit coupled to the memory storage, wherein the processing unit is configured to:
establish a primary community based on input variables;
match the primary community with a primary cross-community;
establish a market based on the primary community and the primary cross-community;
provide a list of bids and offers associated with the market established based on the primary community and the primary cross-community;
enable a user to apply at least one of: a bid or an offer within the market, wherein the bid or the offer is configured to be associated with data aggregated from a plurality of users in at least one of the following: within the market and within other markets; and
enable channels of communication for interacting with the listed bids and offers associated with the market.

6. The system of claim 5, wherein the processing unit being configured to enable the user to apply the bid comprises the processing unit being configured to enable the user to form a user group for aggregating a plurality of bids from the plurality of users.
